(19) United States
(12) Patent Application Publication
(10) Pub. No.: US 2003/0173426 A1
(43) Pub. Date: Sep. 18, 2003

(54) Yield point-controlled threaded joint

(76) Inventor: Hrvoje Lalic, Ludwigsburg (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/276,860

(22) PCT Filed: Mar. 22, 2002
(86) PCT No.: PCT/DE02/01041

(30) Foreign Application Priority Data
Mar. 23, 2001 (DE) 101 14 216.1

(51) Int. Cl. F02M 59/00

(52) U.S. Cl. 239/533.2

(57) ABSTRACT

The invention relates to a screw connection between components (2, 5) of a structural part (1) subjected to high operating pressure, such as an injector for injecting fuel into the combustion chambers of an internal combustion engine. A local reduction (19) of a cross-sectional area that enables a plastic deformation is embodied on one of the components (2, 5) of the screw connection (3).

### FIELD OF THE INVENTION

Injectors in injection systems for injecting fuel into the combustion chambers of internal combustion engines are exposed to extremely high pressures. In order not to impair the efficiency of fuel injectors, stringent demands must be made in terms of the tightness that the individual structural components of a fuel injector must have. In multiple-part fuel injectors, as a rule an injector body and a nozzle body are screwed together via a nozzle lock nut. It must be assured here that the parts braced against one another via the screw connection rest flatly on one another, in order not to impair the sealing action.

### PRIOR ART

In the production of fuel injectors, for instance for use in fuel injection systems with high-pressure collection chambers (common rails), leaks can occur in the mounting of the injector body and nozzle lock nut. These leaks can have various causes, such as an excessive surface roughness of the structural parts resting on one another at a sealing face, overly low pressure per unit of surface area between the structural parts because the axial prestressing force is too low, or an uneven distribution of the pressure per unit of surface area on the circumference.

The uneven distribution of the axial force can be ascribed for the most part to deviations from planarity. These deviations from planarity can occur between the sealing face and the injector body, between the sealing face and the nozzle, between a shoulder and the nozzle, and between the shoulder and the nozzle lock nut. If the components with deviations from planarity are in an unfavorable position in the preassembled state of the fuel injector, then low pressures per unit of surface area can occur, and at the maximum pressures that occur in the injector in fuel injection systems their sealing action is reduced considerably. As a consequence, leaks occur at the fuel injector, even though its components, that is, the injector body and the nozzle lock nut, are screwed together with the correct tightening moment. The consequence is leaks that impair the efficiency of the injector as well as an oil-smeared cylinder head region of the engine, because of the creepage properties of fuel once it has escaped.

### SUMMARY OF THE INVENTION

The advantages of the provision proposed by the invention, of providing a plunge cut on the nozzle lock nut of a fuel injector, allows a plastic deformation of the material comprising the nozzle lock nut at the end of a screwing operation within an automated screwing station. By means of a plunge cut, for instance at the circumferential surface of the nozzle lock nut, the cross-sectional area thereof is locally reduced in the region of this weakening and represents a rated region, embodied on the nozzle lock nut, at which the nozzle lock nut will deform plastically once its material has reached the yield point. Depending on the material used for the nozzle lock nut of a fuel injector, the cross section is selected such that at the desired mounting force in an automated screwing station, the yield point R_{p 0.2} of the material comprising the nozzle lock nut will be reliably reached.

The outside diameter of the nozzle lock nut can be derived approximately from performance graph relationships. The choice of a greater axial force to be generated or of a softer material will lead to increasing the requisite cross section, or in other words the outside diameter D of the nozzle lock nut. For the same tolerances, this means lesser deviation caused by geometry in the axial force, for instance caused by deviations from rated diameters and deviations in terms of the coaxial nature of the inside diameter relative to the outside diameter.

If the axial force is distributed unevenly over the circumference, then in the region where the axial force is greater, the flow of material upon plastic deformation once the yield point is reached creates a greater deformation travel, which in turn makes a more-uniform distribution of the pressure per unit of surface area achievable. This brings about an improvement in the sealing action of the components joined together at the injector by way of the screw connection proposed.

An especially precise tightening method for creating defined tightening moments in automated screwing stations is elongation-limit-controlled screwing. In this case, the onset of yielding, for instance of the material comprising the nozzle lock nut (or of a screw) serves as an actuating variable for the mounting prestressing force. The control of the automated screwing station is done in conjunction with the relationship Δ mounting moment/Δ angle of rotation, which has a maximally linear course in Hooke's range. Not until the yield point is reached does the curve change its course.

### DRAWING

The invention is described in further detail below in conjunction with the drawing.

Shown are:

FIG. 1, leaks that occur between the structural components of a fuel injector because of deviations from planarity of the components, as well as the unevenly distributed axial force;

FIG. 2, a nozzle lock nut, screwed to an injector body, with a weakened region of reduced wall thickness, and also the associated detail marked X shown on a larger scale;

FIG. 3, the individual moments that engage the nozzle lock nut; and

FIG. 4, the definitive relationship for a screwing station of A mounting force/Δ angle of rotation.

### VARIANT EMBODIMENTS

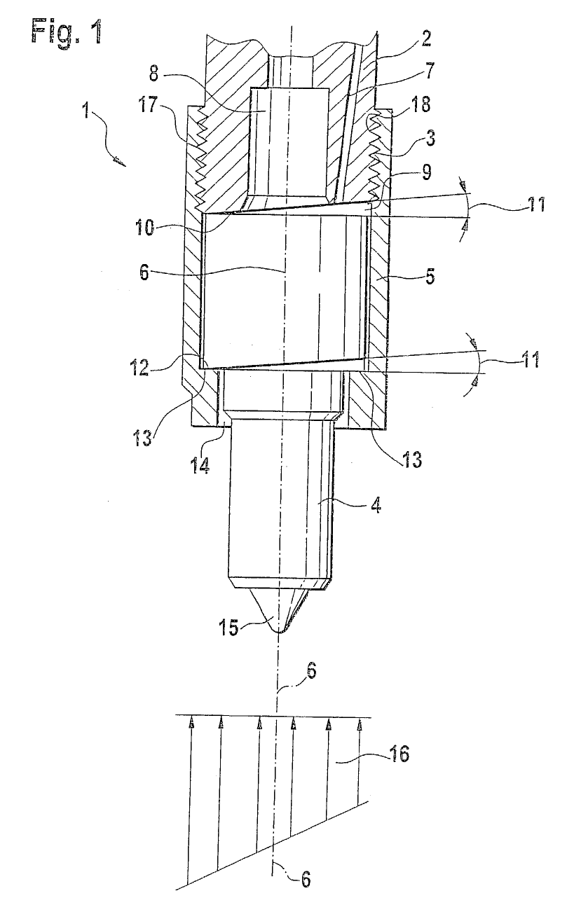

FIG. 1 shows leaks that occur between the individual structural components of a fuel injector because of deviations from planarity of the components, and also shows the resultant uneven distribution of axial force.

A fuel injector 1 comprising a plurality of components that are to be joined together essentially includes an injector body 2, which by means of a nozzle lock nut 5 receives a nozzle body 4. The injector body 2 and the nozzle body 4 as well as the nozzle lock nut 5 are embodied as rotationally symmetrical structural parts, symmetrical to the axis of symmetry 6. In the injector body 2, a central bore 8 is embodied, as is a high-pressure inlet bore 7, extending slightly inclined to the central bore and essentially parallel to the axis of symmetry 6; a nozzle needle—not shown here—received displaceably in the nozzle body 4 and a nozzle chamber surrounding the nozzle needle are acted upon through this inlet bore.

From the illustration in FIG. 1 it can be seen that the nozzle body 2 and the nozzle lock nut 5 that receives nozzle body 4 do not rest flatly on one another in the sealing region between the end faces pointing toward one another; instead, an oblique position 11, identified by an angle shown exaggerated here, has come about.

Because of deviations from planarity of the injector body 2, or the head, embodied with a larger diameter, of the nozzle body 4, the oblique positions shown in FIG. 1 can occur not only at the parting line 10 between the injector body 2 and the nozzle body 4 but also in the region of the seat face 13, that is, an annular portion embodied on the inside of the nozzle body 4. As shown in FIG. 1, the nozzle body 4, because of deviations from planarity, has come to be obliquely positioned relative to the seat face 13 extending annularly on the inside of the nozzle lock nut 5; this is indicated by means of the deflection, marked by reference numeral 11, of the nozzle body seat 12 relative to the seat face 13 of the nozzle lock nut 5.

For the sake of completeness, it should be noted that the nozzle body 4, in its end that protrudes into the combustion chamber of an internal combustion engine not shown here, is provided with a nozzle cone 15 of domelike form, by way of which the injection of fuel that is at high pressure takes place into the combustion chamber of the engine.

Below the illustration of the injector 1 that has leaking points, the axial force distribution 16 that ensues in an injector mounted in this way, and essentially comprising the injector body 2, nozzle body 4 and nozzle lock nut 5, is shown. It can be seen from the illustration of the axial force distribution 16 that the greatest axial forces occur in the region where there is material contact between the injector body 2 and the head of the nozzle body 4 along the parting line 10, or between the nozzle body seat 12 and the annular face 13 embodied on the inside of the nozzle lock nut 4. The axial force 16 is intrinsically at its least on the opposite sides, that is, in the regions where the most-pronounced oblique positions 11, shown exaggerated here, occur. Because of the axial force distribution 16 shown in FIG. 1 at the structural components 2, 4 and 5 shown, an uneven distribution of the pressure per unit of surface area on the circumference occurs, which leads to leaks between the injector body 2 and the nozzle body 4, or between the nozzle body seat face 12 and the annular face 13 on the nozzle lock nut 5.

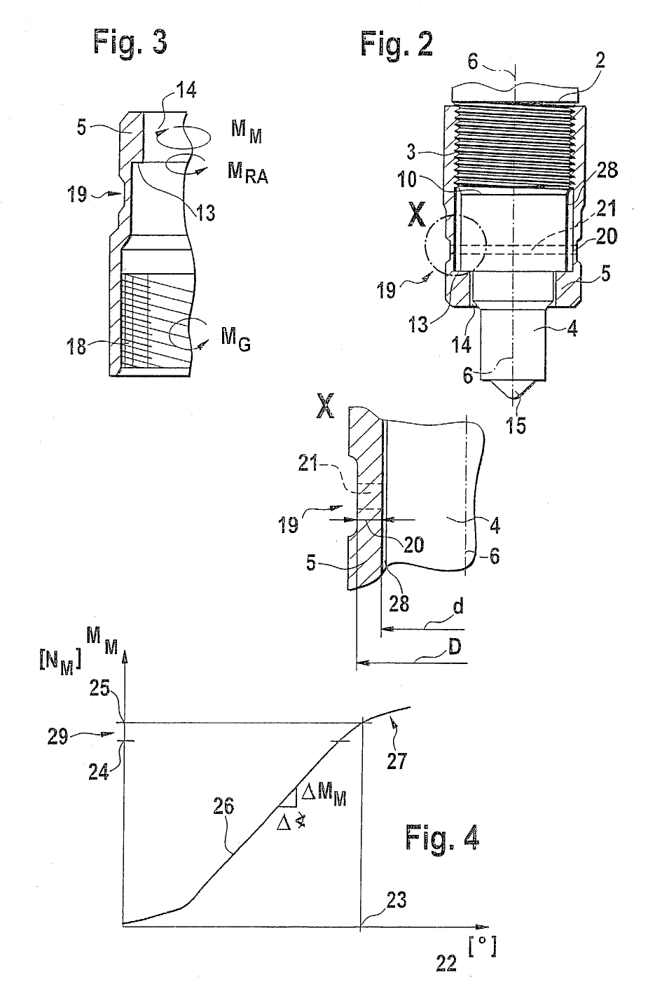

FIG. 2 shows a nozzle lock nut, screwed to an injector body and having a weakened region embodied with a reduced wall thickness, and also shows the associated detail marked X, shown on a larger scale.

From the illustration in FIG. 2, it can be seen that the injector body 2 and the nozzle lock nut 5 that receives the nozzle body 4 are screwed together at the screw connection 3. To that end, the injector body 2 is provided with a male thread 17 (see FIG. 1), while a female thread 18 (see the illustration in FIG. 1) is provided on the inside of the nozzle lock nut 5. As shown in FIG. 2, both the injector body 2 and the face end, pointing toward it, of the nozzle body 4 rest on one another in the region of the parting line 10.

The reinforced head region of the nozzle body 4 is surrounded by the nozzle lock nut 5 in such a way that an annular gap 28 is formed between the circumferential surface of the head region of the nozzle body 4 and the inside of the nozzle lock nut 5.

The outer circumference of the nozzle lock nut 5 is embodied in the region 19 of the reduced cross-sectional area 21. In this region, there is a reduced wall thickness 20, which is less than the wall thickness with which the nozzle lock nut 5, outside the region with the reduced cross-sectional area 21, is manufactured.

The nozzle body 4 rests with its nozzle body seat face 12 on the seat face 13 embodied on the inside of the nozzle lock nut 5 and penetrates a bore 14 on the underside of the nozzle lock nut 5.

The reduced cross-sectional area 21, shown on a larger scale, of the nozzle lock nut 5 can be seen from the detail marked X. Depending on the mounting force required to create a screw connection 3 associated with high sealing action between the components 2, 4 and 5 that are acted upon by pressure of the fuel injector as shown in FIG. 2, the cross-sectional area 21 in the weakened region 19 is selected such that at the desired mounting force, the yield point R_{p 0.2} of the material comprising the nozzle lock nut 5 is achieved with certainty. The yield point R_{p 0.2} is determined in accordance with the following relation:

$$\sqrt{{( \frac{{F}_{M}}{A} )}^{2} + 3 {x ( \frac{{M}_{G}}{{W}_{t}} )}^{2}} = {R}_{p 0 , 2}$$

in which

F_{M}=mounting force

A=cross section 21

M_{G}=thread moment

Wₜ=torsion resistance moment in cross section 21.

The material weakening in the region 19 of the nozzle lock nut 5 is achieved by a reduction in the outside diameter D of the nozzle lock nut 5, so that the result is a reduced wall thickness 20 in the region 19 relative to the inside diameter d of the nozzle lock nut 5. As a result, the reduced cross-sectional area 21 in the region 19 of the nozzle lock nut 5 is defined by the relationship π(D²-d²)/4. The outside diameter D can be approximately determined, for instance graphically, using suitable performance graphs. The choice of a greater axial force 16 or a softer material from which the nozzle lock nut 5 is to be manufactured leads to an enlargement of the requisite cross section in the region 19, or in other words an increase in the outer diameter D. From the illustration in FIG. 3, the individual moments that engage the nozzle lock nut 5 can be seen.

In the region of the female thread 18 of the nozzle lock nut 5, the thread moment is operative, which is represented by the following equation:

M_{G}=F_{M}·(0.16·P+0.58·d₂·μ_{G}), in which

P=pitch of the thread

d₂=flank diameter of the screw thread and

μ_{G}=coefficient of friction in the thread.

In the region of the seat face 13 that is embodied on the inside of the nozzle lock nut 5, the friction moment M_{RA} is operative, which from the contact of the nozzle body seat 12 on the seat face 13 of the nozzle lock nut 5 reduces the mounting moment M_{M}. In the region of the opening 14 in the nozzle lock nut 5, only the mounting torque that is required to generate the axial prestressing force 16 is operative. Both the thread moment MG and the frictional moment M_{RA} are oriented in the same direction as one another, while the mounting torque is oriented oppositely from of the moments M_{RA} and M_{G}.

From the illustration in FIG. 4, the definitive relationship of Δ mounting moment/Δ angle of rotation that is definitive for an automatable screwing station can be seen.

In large-scale mass-production applications, screw connections 3, for instance between the injector body 2 and a nozzle lock nut 5 of an injector 1, are produced in automated screwing stations. Depending on the material from which the component, such as the nozzle lock nut 5, that has a reduced cross-sectional area 21 in one region 19 is manufactured, a moment margin of safety 29, ascertained by experiments, of a control of an automated screwing station is made available in convertible form.

After that, the injector body 2 is fastened with a chuck in the automated screwing station, and then the nozzle lock nut 5, with the nozzle body 4 laid in it, is screwed to the male thread 17 of the injector body 2. At first there is a continuous increase in the mounting moment M_{M} corresponding to the desired mounting force, that is, the axial force 16. During the below the onset of yielding 24 of the material used, from which the nozzle lock nut 5 is manufactured, the stress in the material comprising the nozzle lock nut 5 increases continuously in accordance with Hooke's straight line 26 shown in FIG. 4. During the screwing together of the nozzle lock nut 5 with the female thread 18 to the male thread 17 of the injector body 2, the attainment of the yield point R_{p 0.2} is recognized from the relationship

$$\frac{Δ mounting moment}{Δ angle of rotation}$$

When the yield point R_{p 0.2} of the material comprising the nozzle lock nut 5 is reached, the onset of yielding 24, which marks the lower limit of a margin of safety 29, ensues. The margin of safety 29 as shown in FIG. 4 is marked by the turn-off point 25 of the automated screwing station. The exceeding of the yield point R_{p 0.2} assures that the material comprising the nozzle lock nut 5 that is provided with a weakened region 19 will in fact also be plastically deformed. Within the margin of safety 29, the material comprising the nozzle lock nut 5 has departed from Hooke's range, represented by the linearly extending straight line 26, and has changed over to the range of plastic deformation 27. The turn-off angle corresponding to the turn-off point 25 of the automated screwing station is marked by reference numeral 23, on the axis of the graph in FIG. 4 that shows the angle of rotation.

The axial force 16 required for optimal sealing action in fuel injectors that are exposed to high operating pressures is obtained, before suitable programming of an automated screwing station, by providing that the axial force 16 is ascertained from screw tests, by the angle tightening method. For calculating the cross-sectional area 21 of the nozzle lock nut 5, the axial force is assumed, and from that, the outside diameter D of the cross-sectional area 21 at which the onset of yielding 24 of the applicable material ensues, once the selected mounting force is reached (see the illustration in FIG. 4), is determined. The most precise tightening method, which should be implemented in the automated screwing station, is that of elongation-limit-controlled screwing, in which the onset of yielding 24 of the material comprising the nozzle lock nut 5 (or some other component, such as a screw) is used as an actuating variable for the mounting prestressing force.

1. A method for creating a screw connection (3) with high sealing action between components (2, 5) of a structural part (1) that is at high operating pressure, such as an injector for injecting fuel, characterized in that one of the components (2, 5) of the screw connection (3) is provided with a cross-sectional area (21), which for a predeterminable mounting force of the components (2, 5) assures the attainment of the yield point R_{p 0.2} of the material comprising one of the components (2, 5).

2. The method of claim 1, characterized in that the screw connection (3) is created in an elongation-limit-controlled screwing station.

3. The method of claim 1, characterized in that the onset of yielding (24) one of the components (2, 5) of the screw connection (3) the mounting prestressing force serves as an actuating variable (4).

4. The method of claim 2, characterized in that the control of the screwing station calculates the quotient of the mounting moment M_{M} and the angle of rotation (22).

5. The method of claim 2, characterized in that upon reaching the onset of yielding (24) of the material comprising one of the components (2, 5), the mounting moment M_{M} is increased, within a margin of safety (29), up to the turn-off point (25).

6. A screw connection between components (2, 5) of a structural part (1) subjected to high operating pressure, such as an injector for injecting fuel, characterized in that a local reduction (19) of a cross-sectional area (21) that enables a plastic deformation is embodied on one of the components (2, 5) of the screw connection (3).

7. The screw connection of claim 6, characterized in that the local reduction (19) of the cross-sectional area (21) is embodied as a reduction in the outside diameter D of the component (2, 5).

8. The screw connection of claim 6, characterized in that the component (2, 5) of the screw connection has a reduced wall thickness (20) at the local reduction (19) of the cross-sectional area (21).

9. The screw connection of claim 6, characterized in that a seat face (13) for a structural part (4) to be axially prestressed is let into one of the components (2, 5) of the screw connection (3).

10. The screw connection of claim 9, characterized in that the seat face (13) in one of the components (2, 5) is designed in ring form.

11. The screw connection of claim 6, characterized in that the components (2, 5) are an injector body and a nozzle lock nut of an injector for injecting fuel into the combustion chambers of an internal combustion engine.
